(19) United States
(12) Patent Application Publication
(10) Pub. No.: US 2016/0235104 A1
(43) Pub. Date: Aug. 18, 2016

(54) ALL NATURAL, NUTRITIONAL, AND FLAVORFUL FROZEN AND LIQUID PRODUCTS AND METHOD OF MAKING SAME

(71) Applicant: Minnie Stinson, Homewood, IL (US)

(72) Inventor: Minnie Stinson, Homewood, IL (US)

(21) Appl. No.: 14/623,020

(22) Filed: Feb. 16, 2015

(51) Int. Cl. A23L 1/302; A23L 2/52

(52) U.S. Cl. CPC A23L 1/302; A23L 2/52; A23V 2002/00

(57) ABSTRACT

This invention provides nutrition and flavor in the form of frozen and liquid products, such as popsicles, smoothies, icy treats, tea, water and juice, by mixing about 0.05% to about 0.5% by total weight of either of the all natural ingredients, and depending on flavor of choice, fruits, fruit puree, citric acid, fruit and vegetable juice, emulsifier, xanthan gum, gum acacia, pomegranate seeds, lavender leaves, eucalyptus leaves, peppermint and spearmint leaves, cucumber, aloe vera leaves, ginger, cinnamon, pumpkin, nutmeg, cocoa, creamer, almonds, natural sweeteners, erythritol, natural flavoring agents, natural extracts, reverse osmosis water, among other all natural ingredients, and adding 0.5 grams of Vitamin C, 5 grams of Vitamin E, and 0.25 grams of Beta Carotene. For the frozen products there may be added a thickener/emulsifier, by mixing about 0.05% to about 0.5% by total weight of either of the natural ingredients, depending on flavor of choice, reverse osmosis water by weight, and adding 0.5 grams of Vitamin C, 5 grams of Vitamin E, and 0.25 grams of Beta Carotene, among other vitamins and minerals.

### TECHNICAL FIELD

This invention relates to mixing a predetermined amount of all natural ingredients, and a predetermined amount of the antioxidants, Vitamin C, Vitamin E, and Beta Carotene, among other vitamins and minerals, for a method of making frozen and liquid products. Frozen products comprising of popsicles, smoothies, icy treat or the like, and close to ice cold and is liquid enough to drink. Liquid products comprising of tea, water, and juice.

### BACKGROUND OF THE INVENTION

Many infants, toddlers, children, teenagers and adults dislike taking medication because of its awkward taste, its smell and appearance, which makes it difficult to ingest. The side effects also can be a deterrent. However, if you noticed, when you come across something that appeals to a few of your senses; looks appetizing and smells enticing, you're more likely to want to taste it. You experience a sudden boost of energy, a sense of excitement and anticipation. With the expectation of an all natural, nutritional, and flavorful frozen and liquid products, individuals will enjoy the taste of these products as they consume antioxidants to nourish the mind, body and spirit.

Many individuals are suffering from illnesses and/or diseases such as diabetes, heart disease, high cholesterol, high blood pressure, common cold symptoms, aging, acne, irregular bowel movements, depression, obesity, and so much more. According to researchers, fruits and vegetables are naturally low in fat, sodium and calories. Therefore, eating fruits and vegetables as part of a healthy regimen, may reduce the risk of certain illnesses and/or diseases.

Natural ingredients comprising of organic, unprocessed and/or unrefined of chemicals, natural enhancers, and/or other natural add-ons, and so much more. Some of the benefits include the following:

(1) more energy; (2) fewer radicals in the system, creating less risk of heart disease, diabetes, cancer, etc.; (3) regular bowel movements; (4) a healthier weight; (5) better sleep; (6) more positive attitude; (7) better concentration and memory retention; (8) more youthful appearance; (9) boost in the oxygenation of your blood.

According to research, the antioxidants Vitamin C, Vitamin E, Beta Carotene, and Catechins helps boost the immune system. Antioxidants can neutralize free radicals before they can cause any damage. Antioxidants help to facilitate digestion and metabolism in the body. Antioxidants also act as a cleaning mechanism in the blood which is great for cardiovascular health.

Listed below are some benefits of the antioxidants, Vitamin C, Vitamin E, Beta Carotene, and Catechins.

Vitamin C includes protection against immune system deficiencies, cardiovascular disease, stroke, cancer, prenatal health problems, eye disease, and skin wrinkling. Most of the studies revealed that consuming 500 milligrams a day of vitamin C is safe to obtain positive health results. Studies have proven that it is safe to consume a maximum limit for vitamin C is 2,000 milligrams a day. Experts say that Vitamin C is one of the safest and most effective nutrients.

Vitamin E is a powerful, fat-soluble antioxidant that helps protect cell membranes against damage caused by free radicals and prevents the oxidation of LDL cholesterol. Vitamin E is necessary for structural and functional maintenance of skeletal, cardiac, and smooth muscle. It also assists in the formation of red blood cells and helps to maintain and store vitamins A and K, iron, and selenium. It may have a positive effect on the immune system, protect against the oxidative damage that can lead to heart disease. It may also have preventive effects against cancer, help relieve symptoms of Alzheimer's disease, and may help prevent some diabetes-related damage, particularly to the eyes. Most of the studies recommended daily dosage for adults and children 14 or older, is 15 mg (or 22.5 IU); pregnant women of any age should get 15 mg (or 22.5 IU); and breastfeeding women of any age should take 19 mg (or 28.5 IU). The recommended daily dosage for children 1-3 years, 6 mg/day (9 IU/day); children 4-8 years, 7 mg/day (10.5 IU/day); children 9-13 years, 11 mg/day (16.5 IU/day).

Beta-carotene is an important flavonoid compound, and has powerful antioxidant functions; it protects the body from damaging molecules called free radicals. Free radicals damage cells through a process known as oxidation. Over time, this damage can lead to a number of chronic illnesses. Research studies suggest that dietary intake of foods high in β-carotene has positive association with decreased risk of cardiovascular disease as well as oral cavity, and lung cancers. There is no Recommended Daily Allowance of beta-carotene. However, according to research, some doctors may prescribe between 10,000 IU per day and up to 83,000 IU.

Catechins are the major group of polyphenols in green tea, and the most active catechins are called epigallocatechin-3-gallate (EGCG). Catechins are a type of antioxidant found in the greatest abundance in the leaves of the tea plant Camellia Sinensis. Catechins are also a type of flavonoid found in certain foods; several forms exist, but all are potent antioxidants that may help protect you from potentially damaging chemicals called free radicals. Other catheins compounds are: catechin, gallaogatechin (GC), epicatehcin (EC), epigallocatechin (EGC), epicatechin gallate (ECG). EGCG is a powerful antioxidant that helps in slowing down the aging process.

According to research and extensive studies, EGCG has the highest level and broadest spectrum of cancer-fighting activity. Studies suggest that consuming 200 to 300 milligrams of EGCG per day is the most beneficial. Many scientists now agree that polyphenols can actually prevent the growth of cancer cells, and kills cancer cells without any harm to the healthy tissues.

These statements have not been evaluated by the Food and Drug Administration. These products are not intended to diagnose, treat, cure, or prevent any disease.

This mixture of all natural ingredients and added antioxidants are to add nutritional support while individuals simultaneously enjoy what they eat or drink.

### DETAILED DESCRIPTION OF THE INVENTION

An all natural, nutritional, and flavorful frozen and liquid products, such as popsicles, smoothies, icy treats, water, juice, and tea, and an added amount of the antioxidants, Vitamin C, Vitamin E, and Beta Carotene.

The frozen and liquid products of this invention are processed in two stages. The first stage is mixing a predetermined amount of either of the all natural ingredients, by weight, and second stage is adding a predetermined amount of the antioxidants, Vitamin C, Vitamin E, and Beta Carotene.

The all natural ingredients includes a predetermined amount, and depending on flavor of choice, comprising of either fruits, fruit puree, citric acid, fruit and vegetable juice, emulsifier, xanthan gum, gum acacia, pomegranate seeds, camellia sinensis leaves, lavender leaves, aloe vera leaves, eucalyptus leaves, peppermint and spearmint leaves, cucumber, ginger, cinnamon, pumpkin, nutmeg, cocoa, creamer, almonds, natural sweeteners, including, but not limited to, erythritol, honey, molasses or bland tasting fruit juices, vanilla extract, spices and reverse osmosis water. Preferably the puree is an amount from about 0.4% to about 2.0% by total weight of the frozen and liquid products. Preferably in the liquid product, the erythritol is an amount less than 1% by weight of said products. Preferably said products do not contain sugars derived from sources other than fruit. Preferably the added sweetener is in an amount at least 10.degree by total weight of the said products, and no more than 11.degree by total weight of the products.

When there's more than one type of fruit present in the product of the invention, the weight equivalent of fruit for each type is calculated and summed. The purpose of this calculation is that the solids provided by the fruits or natural sweeteners are considered part of the fruit serving.

The products have about 0.05% to about 0.5% by total weight of the products of a galactomannan. Guar gum, locust bean gum and tara gum are galactomannans. Preferably, the galactomannan is selected from the group comprising of locust bean gum, guar gum, and other blends. Preferably the galactomannan contains about 50% to about 90% locust bean gum and about 10% to about 50% guar gum. Preferably, the galactomannan contains about 0.12% to about 0.30% locust bean gum by weight of the frozen products, and about 0.4% to about 0.20% guar gum by weight of said products. Xanthan gum is added so that the fat will not separate out, and provide a smoother end result.

Preferably, there is one full serving of fruit contained in each 2.1 fluid ounce of serving product. A serving of fruit is considered to be 4 fl. oz. of fruit. The invention provides the equivalent of 4 fl. oz. of fruit in a 2.1 fluid ounce of product by providing the same amount of fruit solids as 4 fl. oz. of fruit. Of course, the amount of reverse osmosis water and solids changes from fruit type to fruit type, and from fruit to fruit. The USDA standardized serving sizes are used for purposes of comparison. The USDA has standardized a serving of apple juice at 4 fluid ounces, having a weight of 123.42 grams, and having a brix value of 11.5%. If 30 grams of apple puree concentrate having a Brix of 38.degree is used then the fruit equivalent of the apple puree concentrate is (30 g.times.38%) (123.42 g.times.11.5%/serving)=0.80 servings.

The frozen and liquid products may contain other natural ingredients, such as ascorbic acid in an amount effective to prevent or reduce oxidation. Other natural ingredients include spices and other flavoring agents. Natural flavors comprising of Pineapple, Watermelon; Coconut; Mixed Berry, Blueberry, Blackberry, Cranberry, Pomegranate, Mango, Banana, Orange, Lemon, Lime, Peach, Cherry, Grape, Tropical Fruit, Green Tea, Aloe Vera, Strawberry, Vanilla, Cinnamon-Vanilla, Lavender-Vanilla, Cucumber, Peppermint; Aloe Vera, Almond-Apple, Cinnamon-Apple, Ginger, Almond, Pumpkin-Cinnamon-Apple, Chocolate, Almond-Apple, Cinnamon-Apple, Ginger, and Pumpkin-Cinnamon.

1. Process of providing all natural, nutritional, and flavorful frozen and liquid products such as popsicles, smoothies, icy treats, tea, water, and juice. Mixing a predetermined amount of either of the all natural ingredients, by weight, depending on flavor of choice, such as fruits, fruit puree, citric acid, fruit and vegetable juice, emulsifier, xanthan gum, gum acacia, erythritol, pomegranate seeds, natural flavoring agents, camellia sinensis leaves, lavender leaves, aloe vera leaves, eucalyptus leaves, peppermint and spearmint leaves, cucumber, ginger, cinnamon, pumpkin, nutmeg, cocoa, creamer, almonds, natural sweeteners, natural extracts, a predetermined amount of reverse osmosis water by weight of said products, a predetermined amount of ice for a time sufficient to eliminate all large pieces and provide a relatively smooth and flowable icy drink, the amount of said ice by weight of said products, and a second step of mixing the antioxidants, comprising of 0.5 grams of Vitamin C, 5 grams of Vitamin E, and 0.25 grams of Beta Carotene, among other vitamins, minerals and natural ingredients.

2. The frozen product provided by the process of mixing a predetermined amount of either of the all natural ingredients, depending on flavor of choice, natural flavoring agents, natural sweeteners, fruits, fruit puree, natural extracts, an amount of reverse osmosis water, by weight, and equal to the weight of the natural ingredients within a range of approximately 10 percent, a predetermined amount of the emulsifier, xanthan gum, gum acacia, and then mixing ice for a time sufficient to eliminate all large pieces of ice, to provide a smooth and flowable iced drink, said amount of ice by weight being between 150 percent and 175 percent of the weight of the frozen product, and mixing antioxidants, comprising of 0.5 grams of Vitamin C, 5 grams of Vitamin E, and 0.25 grams of Beta Carotene, among other vitamins, minerals and natural ingredients.

3. The liquid product, such as water, tea and juice provided by the process of mixing a predetermined amount of either of the all natural ingredients, depending on flavor of choice, less than 1% of erythritol, citric acid, fruit and vegetable juice, gum acacia, reverse osmosis water, by weight, and equal to the weight of the natural ingredients within a range of approximately 10 percent, and mixing the antioxidants, comprising of 0.5 grams of Vitamin C, 5 grams of Vitamin E, and 0.25 grams of Beta Carotene, among other vitamins, minerals and natural ingredients.
